(19) United States
(12) Patent Application Publication
(10) Pub. No.: US 2024/0046813 A1
(43) Pub. Date: Feb. 8, 2024

(54) SYSTEM AND METHOD FOR VIRTUAL DRIVING SIMULATION

(71) Applicant: HYUNDAI MOBIS CO., LTD., Seoul (KR)

(72) Inventors: Jae Joong KIM, Seoul (KR); Bo Young PARK, Seongnam-si (KR); Young Ji HWANG, Seoul (KR); Sang Il CHUNG, Seongnam-si, Gyeonggi-do (KR)

(73) Assignee: HYUNDAI MOBIS CO., LTD., Seoul (KR)

(21) Appl. No.: 18/229,428

(22) Filed: Aug. 2, 2023

(30) Foreign Application Priority Data
Aug. 3, 2022 (KR) 10-2022-0096936

(51) Int. Cl. G09B 9/05

(52) U.S. Cl. CPC G09B 9/05

(57) ABSTRACT

A virtual driving simulation system and a virtual driving simulation method are disclosed. A digital twin device according to an embodiment of the present invention includes a virtualization implementation part to generate virtualization data, a model generation part to generate virtual driving data, and a communication part to transmit the virtual driving data to a simulation cabin and a simulation wall, wherein the simulation cabin includes at least one pillar display, and the virtual driving data includes a video to be displayed on the at least one pillar display.

### CROSS REFERENCE TO RELATED APPLICATION

The present application claims priority to Korean Patent Application No. 10-2022-0096936, filed Aug. 3, 2022, the entire contents of which is incorporated herein for all purposes by this reference.

### BACKGROUND OF THE INVENTION

### Field of the Invention

The present invention relates to virtual reality and, more particularly, to a system and a method of a virtual driving simulation that provides a digital twin virtual driving environment.

### Description of the Related Art

A digital twin is a technology that can predict problems, which may raise in the reality and respond effectively by implementing the shape, function, and process of an object existing in the real world through interconnected networks in real-time throughout the life cycle. Recently, the digital twin technology has been introduced to the automobile industry. For example, after applying the digital twin to create and simulate a vehicle model that is the twin of reality in virtual space, the data obtained through the simulation linked to the vehicle to achieve innovation in products and production processes simultaneously. Using digital twin technology, it can reflect power flow, resistance, and interlocking relationship between parts in product design without having to manufacture multiple vehicle prototypes. In addition, the virtual world, similar to the real world, may be implemented using digital twin technology. A virtual driving test in such a virtual world may be performed. When implementing various cities through the virtual world and performing the virtual driving test in the virtual world, a 24-hour virtual driving may be possible where the number of vehicles is driven simultaneously, and as a result, the test for developing vehicles may be done in a short time using such a technology. In addition, by using digital twin technology, autonomous driving algorithms may be advanced in a short period of time.

On the other hand, a virtual driving simulation system is an integrated virtual reality device that simulates in real time the motion of the vehicle caused by the operation of the steering wheel, acceleration and deceleration pedals, and the like, performed by the driver while driving the vehicle, and feedbacks the results to the driver through motion, visual and sound signals, thereby giving the driver in the simulator the feeling of actually driving the vehicle. Various types of driving simulators are developed and operated locally and abroad, and most virtual driving simulation systems use an actual vehicle as the cabin, which is the driver's seat of the simulator, and install a motion platform at the bottom, and add longitudinal and transverse rails to improve driving reality. The virtual driving simulation system includes an image and sound system that reproduces the actual driving environment through virtual road images and sounds, dynamics of the vehicle that the driver feels when driving a real vehicle, a recording device that records driving information, and a bio-signal measurement system that collects the response of the driver.

On the other hand, conventional virtual driving simulation systems are most suitable for manually operated vehicles with a driver's seat, and since the conventional virtual driving simulation systems use the platform of existing vehicles, they are not suitable for future mobility with different seat shapes and interior spaces.

Accordingly, in the art, there is a need for a virtual driving simulation system suitable for mobility with various seat shapes and interior spaces in advance.

### SUMMARY OF THE INVENTION

Therefore, the present invention has been made in view of the above problems, and it is a technical object of the present invention to provide a virtual driving simulation system by creating a digital twin of a real driving environment.

Another technical object of the present invention is to provide a future mobility driving experience through a virtual driving simulation system, obtaining occupant data, and evaluating augmented reality (AR) information linked to driving image.

The technical objects to attain in the present invention are not limited to the above-described technical objects and other technical objects which are not described herein will become apparent to those skilled in the art from the following description.

To accomplish the above objects, according to one aspect of the present invention, there is provided a virtual driving simulation method including generating, by a virtualization implementation part; generating, by a model generation part, modeling data; generating, by a simulation implementation part, virtual driving data; and transmitting, by a communication part, the virtual driving data to a simulation cabin and a simulation wall, wherein the simulation cabin includes at least one pillar display, and the virtual driving data includes an image to be output on at least one pillar display.

In this case, the image to be output to the at least one pillar display may include video see-through and augmented reality (AR) image data synchronized with the simulated wall.

The generating the virtualization data may include receiving, from a data server, real-world environmental data for a virtual driving environment to be a background for virtual driving and data on mobility to drive the virtual driving environment and generating the virtualization data based on the real-world environment data and the data on the mobility.

The modeling data may be generated by performing a modeling operation on the virtualization data for representation in a digital twin environment.

The virtual driving data may be generated by a combination of the virtualization data and the modeling data.

The virtual driving data may include mobility data and driving environment data.

The mobility data may include at least one of a driving direction, a turning angle, or a speed of the vehicle, or a combination thereof.

The driving environment data may include at least one of ambient traffic conditions, road conditions, or weather conditions, or a combination thereof.

The transmitting of the virtual driving data, the virtual data transmitted to the simulation cabin, and the simulation wall may be data that is synchronized in real-time.

A digital twin device according to an embodiment of the present invention including: a virtualization implementation part for generating modeling data, a simulation implementation part generating virtual driving data, and a communication part for transmitting the virtual driving data to a simulation cabin and a simulation wall, wherein the simulation cabin includes at least one pillar display, and the virtual driving data includes an image to be output to the at least one pillar display.

The image to be output to the at least one pillar display may include video see-through and augmented reality (AR) image data synchronized with the simulation wall.

The virtualization data may be generated based on real-world environment data on a virtual driving environment to be a background for virtual driving received from a data server, and data on a mobility to drive the virtual driving environment.

The modeling data may be generated by performing a modeling operation on the virtualization data for representation in a digital twin environment.

The virtual driving data may be generated by a combination of the virtualization data and the modeling data.

The virtual driving data may include mobility data and driving environment data.

The mobility data may include at least one of a driving direction, a turning angle, or a speed of the vehicle, or a combination thereof.

The driving environment data may include at least one of ambient traffic conditions, road conditions, or weather conditions, or a combination thereof.

The virtual driving data transmitted to the simulation cabin and the simulation wall may be data synchronized in real-time.

A virtual driving simulation system according to an embodiment of the present invention, including: a digital twin device for generating virtual driving data; a data server for collecting and providing to the digital twin device external data of a real-world environment to be a background for virtual driving; a simulation wall for displaying an image of the virtual driving environment on a screen based on the virtual driving data generated by the digital twin device; and a simulation cabin providing a sense of virtual driving to occupants based on the virtual driving data generated by the digital twin device, wherein the simulation cabin includes at least one pillar display, and the virtual driving data includes an image to be output to the at least one pillar display.

The image to be output to the at least one pillar display may include video see-through and augmented reality (AR) image data synchronized with the simulation wall.

The external data may include at least one of traffic conditions, road conditions, signaling systems, or weather data, or a combination thereof.

The simulation cabin may include a pillar display for displaying on the screen video see-through and augmented reality (AR) image data synchronized with the simulation wall included in the virtual driving data, a mechanical drive part for implementing movement of the simulation cabin via a motor based on movement data included in the virtual driving data, a vibration generation part for generating vibration within the simulation cabin via a vibration motor based on vibration data included in the virtual driving data, and a speaker for generating sound based on sound data included in the virtual driving data.

The digital twin device may include a virtualization implementation part for generating virtualization data, a model generation part for generating modeling data, a simulation implementation part generating virtual driving data, and a communication part for transmitting the virtual driving data to the simulation cabin and the simulation wall. A virtual simulation method according to an embodiment of the present invention for implementing the objects above mentioned includes generating, by a virtualization implementation part, virtualization data; generating, by a model generation part, modeling data; generating, by a simulation implementation part, virtual driving data; and transmitting, by a communication part, the virtual driving data to a simulation cabin and a simulation wall, wherein the simulation cabin includes at least one pillar display, and the virtual driving data includes an image to be displayed on the at least one pillar display.

The image to be output to the at least one pillar display may include video see-through and augmented reality (AR) image data synchronized with the simulation wall.

The generating the virtualization data may include receiving, from a data server, real-world environment data for virtual driving environment to be a background for virtual driving, and data on a mobility to drive the virtual driving environment and generating the virtualization data based on the real-world environment data and the data on the mobility.

The modeling data may be generated by performing the modeling operation on the virtualization data for representation in a digital twin environment.

The virtual driving data may be generated by a combination of the virtualization data and the modeling data.

The virtual driving data may include mobility data and driving environment data.

The mobility data may include at least one of a driving direction, a turning angle, or a speed of the vehicle, or a combination thereof.

The driving environment data may include at least one of ambient traffic conditions, road conditions, or weather conditions, or a combination thereof.

In the transmitting the virtual driving data, the virtual driving data transmitted to the simulation cabin and the simulation wall may be data that is synchronized in real-time.

In addition, a digital twin device according to an embodiment of the present invention includes a virtualization implementation part generating virtualization data, a model generation part generating virtual driving data, a simulation implementation part generating virtual driving data, and a communication part transmitting the virtual driving data to a simulation cabin and a simulation wall, wherein the simulation cabin includes at least one pillar display, and the virtual driving data includes an image to be displayed on the at least one pillar display.

The image to be output to the at least one pillar display may include video see-through and augmented reality (AR) image data synchronized with the simulation wall.

The virtualization data may be generated based on real-world environment data on a virtual driving environment to be a background for virtual driving received from a data server, and data received from a data server, and data on a mobility to drive the virtual driving environment.

The modeling data may be generated by performing a modeling operation on said virtualization data for representation in a digital twin environment.

The virtual driving data may be generated by a combination of the virtualization data and the modeling data.

The virtual driving data may include mobility data and driving environment data.

The mobility data may include at least one of a driving direction, a turning angle, or a speed of the vehicle, or a combination thereof.

The driving environment data may include at least one of ambient traffic conditions, road conditions, or weather conditions, or a combination thereof.

The virtual driving data transmitted to the simulation cabin and the simulation wall may be data synchronized in real-time.

In addition, a virtual driving simulation system according to an embodiment of the present invention, including: a digital twin device for generating virtual driving data; a data server for collecting and providing to the digital twin device external data of a real-world environment to be a background for virtual driving; a simulation wall for displaying an image of the virtual driving environment on a screen based on the virtual driving data generated by the digital twin device; and a simulation cabin for providing a sense of virtual driving to occupants based on the virtual driving data generated by the digital twin device, wherein the simulation cabin includes at least one pillar display, and the virtual driving data includes an image to be output to the at least one pillar display.

The image to be output to the at least one pillar display may include video see-through and augmented reality (AR) image data synchronized with the simulation wall.

The external data may include at least one of traffic conditions, road conditions, signaling systems, or weather data, or a combination thereof.

The simulation cabin may include a pillar display for displaying on the screen video see-through and augmented reality (AR) image synchronized with the simulation wall included in the virtual driving data, a mechanical drive part for implementing movement of the simulation cabin via a motor based on movement data included in the virtual driving data, a vibration generation part for generating vibration within the simulation cabin via a vibration motor based on vibration data included the virtual driving data, and a speaker for generating sound based on sound data included in the virtual driving data.

The digital twin device may include a virtualization implementation part generating virtualization data, a model generation part generating modeling data, a simulation implementation part generating virtual driving data, and a communication part transmitting the virtual driving data to the simulation cabin and the simulation wall.

As described above, various embodiment of the present invention may provide a virtual driving simulation system that creates digital twins of real-world driving environments and mobility and integrates therewith in real-time.

In addition, it provides simulations of future fully autonomous driving situations by operating mobility under the assumption of driverless driving.

In addition, by providing virtual reality information on the virtual driving environment image through a pillar display, augmented reality (AR) information can be provided and evaluated.

In addition, driving simulation is possible not only in the general vehicle layout of driver, occupant, and rear seats, but also in various types of seat positions and mobility structures that utilize interior space.

In addition, mobility can also be used as a driving experience and as exhibition, creating experiences for both occupants inside and viewers outside the vehicle.

Advantages which may be obtained in this specification are not limited to the aforementioned advantages, and various other advantages may be evidently understood by those skilled in the art to which the present invention pertains from the following description.

### BRIEF DESCRIPTION OF THE DRAWINGS

FIG. 1 schematically illustrates the overall structure of a virtual driving simulation system according to an embodiment of the present invention.

FIG. 2 schematically illustrates the structure of a simulation cabin according to an embodiment of the present invention.

FIG. 3 illustrates an example of a simulation wall and pillar display screen that can be viewed from a occupant's view in a simulation cabin according to an embodiment of the present invention.

FIG. 4 is a block diagram illustrating a schematic configuration of a virtual driving simulation system according to an embodiment of the present invention.

FIG. 5 is a flow diagram illustrating a virtual driving simulation method according to an embodiment of the present invention.

### DETAILED DESCRIPTION OF THE INVENTION

Hereinafter, embodiments of the present invention will be described in greater detail with reference to the accompanying drawings. In describing the present invention, for ease of understanding, the same reference numerals are used to denote the same components throughout the drawings, and repetitive description on the same components will be omitted. In the following description, with respect to constituent elements used in the following description, suffixes “module” and “unit” are given in consideration of only facilitation of description and do not have meaning or functions discriminated from each other. In addition, in the following description of the embodiments disclosed in the present specification, a detailed description of known functions and configurations incorporated herein will be omitted when it may make the subject matter of the embodiments disclosed in the present specification rather unclear. In addition, the accompanying drawings are provided only for a better understanding of the embodiments disclosed in the present specification and are not intended to limit technical ideas disclosed in the present specification. Therefore, it should be understood that the accompanying drawings include all modifications, equivalents and substitutions within the scope and spirit of the present invention.

Terms such as “first” and “second” may be used to describe various components, but the components should not be limited by the above terms. In addition, the above terms are used only for the purpose of distinguishing one component from another.

It will be understood that when a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless context clearly indicates otherwise.

In the present application, it will be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

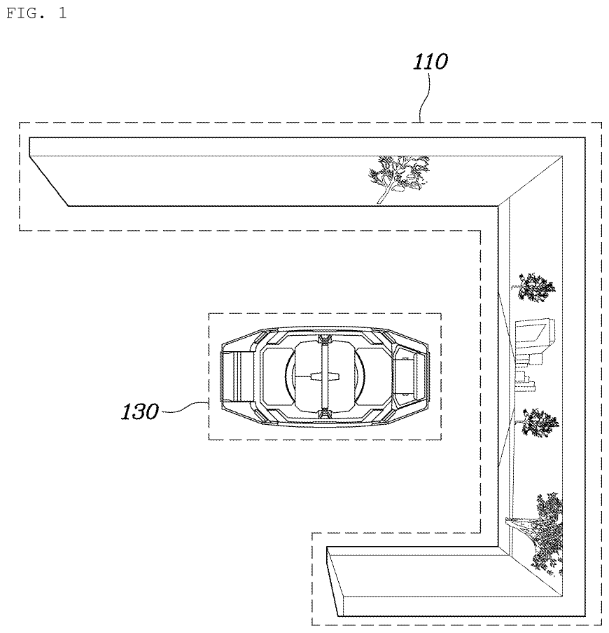

FIG. 1 schematically illustrates the overall structure of a virtual driving simulation system according to an embodiment of the present invention.

Referring to FIG. 1, a virtual driving simulation system according to the present embodiment includes a simulation wall 110 and a simulation cabin 130 surrounded by the simulation wall 110.

The simulation wall 110 displays real-time image of a virtual driving environment created in advance.

The simulation wall 110 may be formed in a semi-closed ‘7’ shaped structure with the front and both sides enclosing the simulation cabin 130.

Accordingly, the simulation wall 110 can show a currently traveling virtual driving environment from the front and sides to an occupant within the simulation cabin 130 and can harmoniously show the simulation cabin 130 and traveling background image thereof to a viewer outside the simulation cabin 130.

The simulation cabin 130 is a space for occupants inside to experience a virtual driving simulation, in which the occupant can view an image of the virtual driving environment displayed on the simulation wall 110 through the front and side glass of the cabin 130.

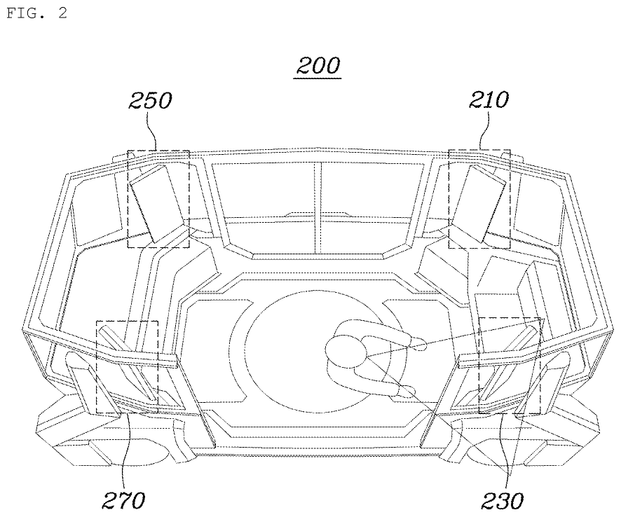

FIG. 2 schematically illustrates the structure of a simulation cabin according to an embodiment of the present invention.

Referring to FIG. 2, the simulation cabin 200 includes first to fourth pillar displays 210, 230, 250, and 270. The first to fourth pillar displays 210, 230, 250, and 270 display images from the position of occupant in the simulation cabin 200 to the images being displayed on the simulation wall in such a way that the images are seamlessly connected based on angle and timing. That is, each of the first to fourth pillar displays 210, 230, 250, and 270 displays the image in such a way as to create a see-through effect that appears to be a window rather than a display. Here, each of the pillar displays 210, 230, 250, and 270 may include an augmented reality (AR) image that includes information about the region of interest and information related to the region of interest. The AR image may include advertising information or discount information in the region of interest.

To implement such a see-through effect, although not shown in FIG. 2, the vehicle may further include a sensor (e.g., camera) for detecting the direction of the occupant's gaze.

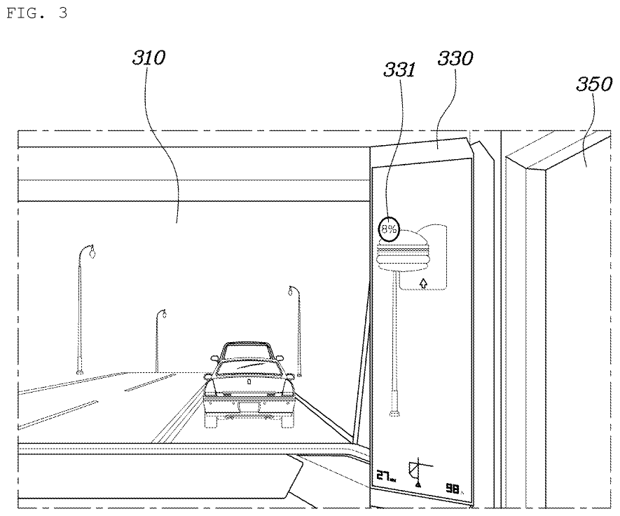

FIG. 3 illustrates an example of a simulation wall and pillar display screen that can be viewed from an occupant's view in a simulation cabin according to an embodiment of the present invention.

In a general vehicle, the pillar is made of metal of plastic to support the vehicle at the joints, such as between the rear and side glasses. On the other hand, the pillars, when made thicker to increase the durability of the vehicle, have the inconvenience of obstructing the driver's view. However, referring to FIG. 3, the pillar display 330 according to the present embodiment mitigated the inconvenience by displaying, for example, through a display screen, a natural connection between the front glass 310 and the side glass 350 where the occupant's view is obstructed, as if through a transparent window.

On the other hand, referring to FIG. 3, the pillar display 330 may include an augmented reality (AR) image 331 that includes information about the region of interest and information related to the region of interest. In this case, the AR image 331 may include advertising information or discount information in the region of interest. Referring to FIG. 3, the AR image 331 may include, for example, information indicating that the region shown in the pillar display 330 is a hamburger restaurant and information about a coupon for a discount at corresponding hamburger restaurant.

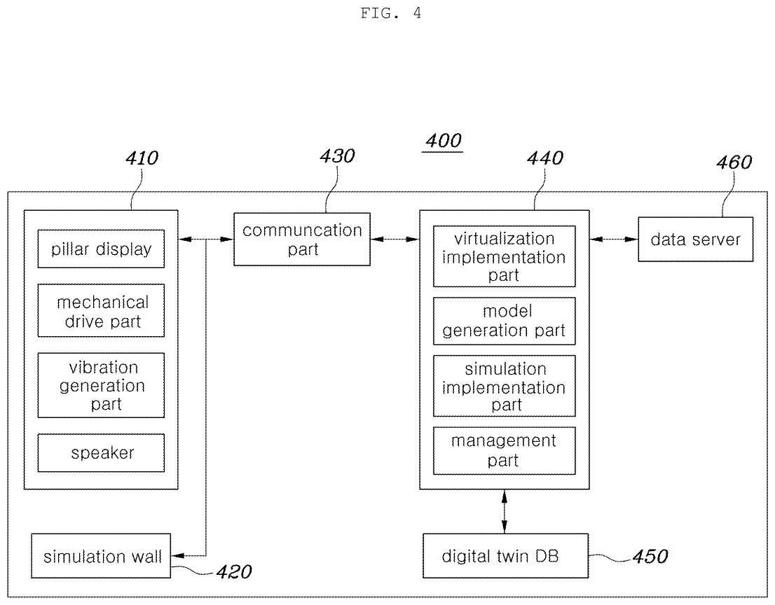

FIG. 4 is a block diagram illustrating a schematic configuration of a virtual driving simulation system according to an embodiment of the present invention.

Referring to FIG. 4, a virtual driving simulation system according to the present embodiment includes a simulation cabin 410, a simulation wall 420, a communication part 430, a digital twin device 440, a digital twin DB 450, and a data server 460. Each of the above constituent component is not an essential component and may be configured to include or omit one or more components. In addition, it may further include components other than these constituent components.

The simulation cabin 410 provides the sense of virtual driving to occupants based on the virtual driving data generated by the digital twin device 440. The simulation cabin 410 includes a pillar display 411, a mechanical drive part 413, a vibration generation part 415, and a speaker 417.

The pillar display 411 receives, via the communication part 430, video see-through and augmented reality (AR) image data synchronized with the simulation wall 420 included in the virtual driving data and displays thereof on the screen. Accordingly, it may be implemented as if an AR image is displayed on a transparent window, such as a normal window from the occupant's view. In addition, AR content may be customized to provide not only the driving information but also an expanded user experience.

The mechanical drive part 413 receives a simulated cabin motion included in the virtual driving data via the communication part 430 and converts the simulated cabin motion into data to implement so that the simulation cabin 410 moves.

The vibration generation part 415 receives a simulated cabin vibration data included in the virtual driving data via the communication part 430 and converts the simulated cabin vibration data into an actual vibration data so that the vibration is generated in the simulation cabin 410 through a vibration motor. Here, the vibration data may include collision, surface vibration, suspension, and the like.

The speaker 417 receives sound data included in the virtual driving data via the communication part 430 and converts the sound data into the acoustic data to generate the sound.

Here, the video see-through and augmented reality (AR) image data, motion data, vibration data, and acoustic data may be data synchronized with each other.

The simulation wall 420 receives the image of virtual driving environment generated by the digital twin device 440 via the communication part 430 and displays thereof on the screen.

The simulation wall 420 may be formed in a semi-closed ‘7’ shaped structure with the front and both sides enclosing the simulation cabin 410.

Accordingly, the simulation wall 420 can show a currently traveling virtual driving environment from the front and sides to an occupant within the simulation cabin 410 and can harmoniously show the simulation cabin 410 and traveling background image thereof to a viewer outside the simulation cabin 410.

The communication part 430 transmits the virtual driving data generated in the digital twin device 440 to the simulation cabin 410 and the simulation wall 420. The communication part 430 may include a Near-Field Communication (NFC) chip, an NFC antenna, a Bluetooth module, a Wi-Fi module, a Long-Term Evolution (LTE) communication module, a 5G communication module, and the like.

Here, the communication part 430 may transmit image data for displaying on the screens of the simulation cabin 410 and pillar display 411, motion data for actuating the mechanical drive part 413, vibration data for operating the vibration generation part 415, and sound data for operating the speaker 417. In addition, the communication part 430 may transmit the image data for displaying on the screens of the simulation wall 420.

Here, the image data for displaying on the screen of the pillar display 411 may be image data that may be displayed such that the image is seamlessly connected to the image displayed on the simulation wall 420 based on angle and timing from the position of the occupant in the simulation cabin 410. That is, the image data for displaying on the screen of the pillar display 411 may be the image data that is displayed such that the pillar display 411 has a see-through effect, so that it appears to be a window rather than a display.

On the other hand, the communication part 430 may be a component in the digital twin device 440 or may be formed as a separate communication device.

The digital twin device 440 generates the virtual driving data to be implemented through the simulation cabin 410 and the simulation wall 420. The digital twin device 440 includes a virtualization implementation part 441, a model generation part 443, a simulation implementation part 445, and a management part 447.

According to an exemplary embodiment of the present disclosure, the digital twin device 440 may include a processor (e.g., computer, microprocessor, CPU, ASIC, circuitry, logic circuits, etc.) and an associated non-transitory memory storing software instructions which, when executed by the processor, provides the functionalities of the virtualization implementation part 441, the model generation part 443, the simulation implementation part 445, and the management part 447. Herein, the memory and the processor may be implemented as separate semiconductor circuits. Alternatively, the memory and the processor may be implemented as a single integrated semiconductor circuit. The processor may embody one or more processor(s).

The virtualization implementation 441 generates the virtualization data.

The virtualization implementation part 441 may receive from the data server 460 real-world environment data for the virtual driving environment to be the background for the virtual driving, and data on the mobility, i.e., the simulation cabin 410, to be driven through that virtual driving environment, and generate virtualization data based on the received real-world environment data and mobility data.

The mobility data may be generated based on the input properties of the mobility, such as vehicle type, color, and hardware and software performance, from the user.

The model generation part 443 generates modeling data by performing modeling operations on the virtualization data generated by the virtualization implementation part 441 for representation in the digital twin environment. In addition, the model generation part 443 may determine by selecting one of a plurality of simulation models (algorithms) for the simulation, which will be performed later.

The simulation implementation part 445 generates the virtual driving data by combining the virtualization data generated in the virtualization implementation part 441 and the modeling data generated in the model generation part 443. Here, the virtual driving data may be a simulation result of a virtual driving of the vehicle. Here, rather than simply combining virtualization and modeling data, virtual driving data is generated by applying physical factors such as interaction and movement between elements in the digital twin environment.

Here, the virtual driving data may include mobility data and driving environment data.

The mobility data includes at least one of a driving direction, a turning angle, or a speed of the vehicle, or a combination thereof.

The driving environment data includes at least one of ambient traffic conditions, road conditions, or weather conditions, or a combination thereof.

The management part 447 manages the driving information based on the simulation result generated in the simulation implementation part 445. The driving information may include information on how the user performs the simulation during driving, and what causes of the accident. The driving information may be used as an analysis data later.

The digital twin DB 450 stores the virtual driving data generated from the digital twin device 440 in real-time, and the stored data is transmitted to the digital twin device 440. The virtual driving data may be a time-series data that transceives between the digital twin DB 450 and the digital twin device 440.

The data server 460 collects external data from the real-world environment that will serve as the background for the digital twin and provides thereof to the digital twin device 440.

The external data may include at least one of traffic conditions, road conditions, or weather conditions, or a combination thereof.

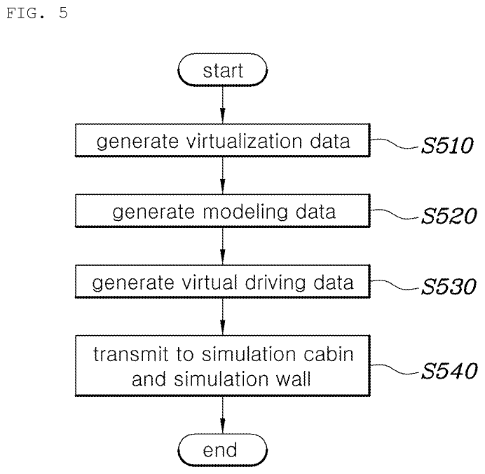

FIG. 5 is a flow diagram illustrating a virtual driving simulation method according to an embodiment of the present invention. The virtual driving simulation method may be performed by each component of a virtual driving simulation system according to the present invention.

Referring to FIG. 5, the digital twin device generates virtualization data (S510).

Here, the digital twin device may receive the real-world environment data about the virtual driving environment that will be the background for the virtual driving and data about the mobility that will drive the virtual driving environment from the data server, that is, the mobility that receives the data about the simulation cabin and generated by based on the received real-world environment data and mobility data.

The mobility data may be generated based on the input properties of the mobility, such as vehicle type, color, and hardware and software performance, from the user.

The generation of virtualization data may be performed by the virtualization implementation part in the digital twin device.

In addition, the digital twin device performs modeling operations on the virtualization data generated in step S510 to generate modeling data for representation in the digital twin environment (S520).

For the simulation to be performed later with the generation of modeling data, one of a plurality of simulation models (algorithms) may be selected and determined.

The generation of the modeling data and the selection of the simulation model may be performed by the model generation part in the digital twin device.

In addition, the digital twin device combines the virtualization data generated in step S510 and the modeling data generated in step S520 to generate virtual driving data (S530).

Here, the virtual driving data may be a simulation result of a virtual driving of the vehicle. Here, rather than simply combining virtualization and modeling data, virtual driving data is generated by applying physical factors such as interaction and movement between elements in the digital twin environment.

Here, the virtual driving data may include mobility data and driving environment data.

The mobility data includes at least one of a driving direction, a turning angle, or a speed of the vehicle, or a combination thereof.

The driving environment data includes at least one of ambient traffic conditions, road conditions, or weather conditions, or a combination thereof.

Here, the generation of the virtual driving data may be performed by the simulation implementation part of the digital twin device.

In addition, the digital twin device transmits the virtual driving data generated in step S530 to the simulation cabin and simulation wall in real time (S540).

The virtual driving data transmitted to a simulation cabin and a simulation wall may be data that is synchronized in real-time.

The simulation cabin and the simulation wall may be remote from the digital twin device and may communicate wirelessly.

The transmission of the virtual driving data may be performed by a communication part in the digital twin device or by a separately provided communication part externally.

The virtual driving data to be transmitted to the simulation cabin and the simulation wall may be implemented by the simulation cabin and the simulation wall.

According to embodiments of the present invention described above, it may be possible to provide a virtual driving simulation system in which the actual driving environment and mobility are created as digital twins and interlocked in real time.

In addition, by operating mobility assuming an autonomous driving situation in which a driver does not exist, simulation in a future fully autonomous driving situation is provided.

In addition, by providing virtual reality information on the virtual driving environment image through a pillar display, augmented reality (AR) information can be provided and evaluated.

In addition, driving simulation is possible not only in the general vehicle layout of driver, occupant, and rear seats, but also in various types of seat positions and mobility structures that utilize interior space.

In addition, mobility can also be used as a driving experience and as exhibition, creating experiences for both occupants inside and viewers outside the vehicle.

The present invention mentioned in the foregoing description may be implemented as code that can be written to a computer-readable recording medium and can thus be read by a computer system. The computer-readable medium may include all kinds of recording devices in which data readable by a computer system is stored. Examples of computer-readable medium includes hard disk drive (HDD), solid state disk (SSD), silicon disk drive (SDD), ROM, RAM, CD-ROM, magnetic tape, floppy disk, optical data storage device, and the like. Therefore, the above embodiments are therefore to be construed in all aspects as illustrative and not restrictive. The scope of the present invention should be determined by the appended claims and their legal equivalents, not by the above description, and all changes coming within the meaning and equivalent range of the appended claims are intended to be embraced therein.

What is claimed is:

1. A virtual driving simulation method, comprising:
generating, by a virtualization implementation part, virtualization data;
generating, by a model generation part, modeling data;
generating, by a simulation implementation part, virtual driving data; and
transmitting, by a communication part, the virtual driving data to a simulation cabin and a simulation wall,
wherein the simulation cabin includes at least one pillar display, and the virtual driving data includes an image to be displayed on the at least one pillar display.

2. The method of claim 1, wherein the image to be output to the at least one pillar display comprises video see-through and augmented reality (AR) image data synchronized with the simulation wall.

3. The method of claim 1, wherein the generating the virtualization data comprising:
receiving, from a data server, real-world environment data for virtual driving environment to be a background for virtual driving, and data on a mobility to drive the virtual driving environment; and
generating the virtualization data based on the real-world environment data and the data on the mobility.

4. The method of claim 1, wherein the modeling data is generated by performing the modeling operation on the virtualization data for representation in a digital twin environment.

5. The method of claim 1, wherein the virtual driving data is generated by a combination of the virtualization data and the modeling data.

6. The method of claim 1, wherein the virtual driving data comprises mobility data and driving environment data.

7. The method of claim 6, wherein the mobility data comprises at least one of a driving direction, a turning angle, a speed of the vehicle, or a combination thereof.

8. The method of claim 6, wherein the driving environment data comprises at least one of ambient traffic conditions, road conditions, weather conditions, or a combination thereof.

9. The method of claim 1, wherein in the transmitting the virtual driving data, the virtual driving data transmitted to the simulation cabin and the simulation wall is the data that is synchronized in real-time.

10. A digital twin device comprising:
a virtualization implementation part generating virtualization data;
a model generation part generating virtual driving data;
a simulation implementation part generating virtual driving data; and
a communication part transmitting the virtual driving data to a simulation cabin and a simulation wall,
wherein the simulation cabin includes at least one pillar display, and the virtual driving data includes an image to be displayed on the at least one pillar display.

11. The device of claim 10, wherein the image to be output to the at least one pillar display comprises video see-through and augmented reality (AR) image data synchronized with the simulation wall.

12. The device of claim 10, wherein the virtualization data is generated based on real-world environment data on a virtual driving environment to be a background for virtual driving received from a data server, and data received from a data server, and data on a mobility to drive the virtual driving environment.

13. The device of claim 10, wherein the modeling data is generated by performing a modeling operation on the virtualization data for representation in a digital twin environment.

14. The device of claim 10, wherein the virtual driving data is generated by a combination of the virtualization data and the modeling data.

15. The device of claim 10, wherein the virtual driving data comprises mobility data and driving environment data.

16. The device of claim 15, the mobility data comprises at least one of a driving direction, a turning angle, a speed of the vehicle, or a combination thereof.

17. The device of claim 15, the driving environment data comprises at least one of ambient traffic conditions, road conditions, weather conditions, or a combination thereof.

18. The device of claim 10, wherein the virtual driving data transmitted to the simulation cabin and the simulation wall is data synchronized in real-time.

19. A virtual driving simulation system comprising:
a digital twin device for generating virtual driving data;
a data server for collecting and providing to the digital twin device external data of a real-world environment to be a background for virtual driving;
a simulation wall that displays an image of the virtual driving environment on a screen based on the virtual driving data generated by the digital twin device; and
a simulation cabin that provides a sense of virtual driving to occupants based on the virtual driving data generated by the digital twin device,
wherein the simulation cabin includes at least one pillar display, and the virtual driving data includes an image to be output to the at least one pillar display.

20. The system of claim 19, wherein the image to be output to the at least one pillar display comprises video see-through and augmented reality (AR) image data synchronized with the simulation wall.
